(19) United States
(12) Patent Application Publication
(10) Pub. No.: US 2021/0280867 A1
(43) Pub. Date: Sep. 9, 2021

(54) CURRENT-CONDUCTING STRUCTURE AND METHOD FOR THE PRODUCTION THEREOF

(71) Applicant: Clarios Germany GmbH & Co. KGAA, Hannover (DE)

(72) Inventors: Juergen Bauer, Hildesheim (DE); Eberhard Meissner, Wunstorf (DE); Ingo Koch, Hameln (DE); Boris Vshnepolskiy, Garbsen (DE)

(21) Appl. No.: 16/338,965

(22) PCT Filed: Oct. 5, 2017
(86) PCT No.: PCT/EP2017/075302

§ 371 Date: Apr. 2, 2019

(30) Foreign Application Priority Data
Oct. 5, 2016 (DE) 102016118863.8

(51) Int. Cl. H01M 4/583; H01M 4/66; H01M 4/68; H01M 4/70; H01M 4/38

(52) U.S. Cl. CPC H01M 4/583; H01M 4/668; H01M 2004/021; H01M 4/70; H01M 4/38; H01M 4/68

(57) ABSTRACT

The invention relates to an electrically conductive structure, particularly for using in an energy storage system of a vehicle, which is formed from a metal or a substance similar to metal at least in sections, containing a plurality of closed pores. The invention also relates to a system respectively comprising at least one of the following elements: a storage battery, particularly a lead storage battery, an electrical pick-up element which is electrically connected to at least one pole of the storage battery, and a structure as described above, which is part of the storage battery and/or the electrical pick-up element. The invention further relates to a method for producing such a structure.

The present invention relates to a current-conducting structure, in particular for use in an energy storage system of a vehicle. The present invention also relates to a method for producing such a structure.

Current-conducting elements, in particular elements on which high currents are conducted over short or long time periods, are conventionally formed solidly in some regions, i.e. with a locally high material density, in order to ensure on the one hand a safe and reliable operating manner and on the other hand sufficient mechanical stability.

However, this has the disadvantage that the weight of these elements or the weight of systems that include such elements is comparatively high.

One possible way of reducing the weight of such elements is to form these elements less solidly, i.e. to reduce the cross section of the elements in order to save material.

With a simple cross-sectional reduction of the element to reduce weight, however, there is a proportionate increase in the electrical resistance, which is accompanied for example by an impairment of the electrical properties, in particular the electrical conductivity. What is more, the mechanical properties of the element, in particular the bending strength and the breaking strength, deteriorate, even disproportionately.

The object of this invention is therefore to provide an improved current-conducting structure that does not have the disadvantages of the prior art and moreover can be produced easily and at low cost.

With regard to the current-conducting structure, the object on which the invention is based is achieved according to the invention by the subject matter of independent patent claim 1. With regard to the method for producing such a structure, the object on which the invention is based is achieved by the subject matter of alternative independent patent claim 15. Advantageous developments are specified in the dependent patent claims.

Therefore, according to the invention, a current-conducting structure, in particular for use in an energy storage system of a vehicle, is provided, the current-conducting structure being formed at least in some regions from a metal or metal-like substance in which a multiplicity of closed pores are formed.

The advantages of the invention are obvious. The structure according to the invention has the effect of reducing the weight, to be precise without impairing the electrical and/or mechanical properties.

The invention is also based on the idea of using porous material to reduce the weight, while likewise realizing that using open-pore material has the following disadvantages. The forming of open pores leads on the one hand to impaired electrical properties, on the other hand to impaired mechanical properties. In order to improve the electrical properties of such elements, the open pores of such an element are made accessible to the electrolyte and are preferably filled with active compound. However, this gives rise to a further disadvantage; specifically that more surface is exposed to a corrosion process.

By contrast with this, the formation of predominantly closed pores has the effect that only the outer surface of the current-conducting structure is exposed to the corrosion process; in particular, no additional surface is exposed to the corrosion process, i.e. the corrosion properties of the structure remain unchanged in comparison with a structure of the same size and shape of a solid form. At the same time, weight and material costs can be saved, since less material has to be used as a result of the porous form of the structure.

According to a further aspect of the invention, the pores may have at least partially a substantially round cross section.

This provides the advantage that no prior alignment or orientation of such pores is necessary, and therefore the production of such a structure is facilitated. This leads in turn to a lowering of the production costs.

According to a further aspect of the invention, the pores may have at least partially a substantially non-round cross section, in particular a substantially oval cross section.

As a result, a preferred direction can be formed. Such a preferred direction influences properties such as for example the electrical and/or thermal conductivity; in particular, these properties are improved.

According to a further aspect of the invention, the structure may have at least in the region of the pores a thickness of at least approximately 2 mm, preferably at least approximately 5 mm, particularly preferably at least approximately 10 mm.

As a result, the structure may advantageously be formed solidly at locations at which it is required for the current conduction and for ensuring the mechanical strength, while the weight of the structure is not overly increased as a result, or the weight can even be lowered.

According to a further aspect of the invention, the pores may be distributed inhomogeneously in the structure, in particular in the current-conducting direction.

An inhomogeneous distribution of the pores means in this context that the pores are not arranged evenly distributed in the structure, but that they are arranged massed in one region, in particular that they are arranged in a region lying in the interior of the structure that runs substantially along the current-conducting direction. As a result, there is an improvement in the electrical and/or mechanical properties, in particular the electrical conductivity.

According to a further aspect of the invention, the pores may have at least partially an anisotropic orientation, to be precise in such a way that at least some of the pores have a non-round cross section, in particular an oval cross section, the longitudinal axis of which is oriented in the current-conducting direction.

This has the advantage that the electrical and/or mechanical properties are increased further, to be precise by the alignment of the pores in the current-conducting direction.

According to a further aspect of the invention, at least some of the pores may be filled with a vacuum, a gas and/or a polymer.

As a result, the weight of the structure is advantageously reduced further.

According to a further aspect of the invention, at least some of the pores may be filled with an electrically conducting material.

This advantageously leads to an improvement in the electrical conductivity, and what is more can additionally reduce the weight of the structure, in particular whenever the filling material is lighter, or has a lower density, than the metal forming the region or the metal-like substance forming the region.

According to a further aspect of the invention, the electrically conducting material may comprise metal, preferably silver, copper, gold, tungsten and/or aluminum, and/or carbon or a carbon-containing substance, carbon fibers or a carbon-fiber-containing substance.

According to a further aspect of the invention, the structure may comprise a first group of pores with a size of approximately 10 μm to approximately 500 μm, preferably with a size of approximately 50 μm to approximately 300 μm, particularly preferably with a size of approximately 100 μm to approximately 200 μm.

Such a structure increases—or at least does not impair—the mechanical stability of the structure. Thus, an optimum compromise between the electrical and mechanical properties can be found.

According to a further aspect of the invention, the structure may comprise a further group of pores with a size of at least 1 mm.

This provides the advantage that on the one hand such a structure can be produced more easily, and on the other hand the pores can be arranged better, in particular can be oriented better. What is more, the electrical and/or thermal conductivity can increase.

According to a further aspect of the invention, the structure may have at least in some regions a pore density of at least approximately 5 pores/cm², preferably at least approximately 10 pores/cm², particularly preferably at least approximately 20 pores/cm².

A higher pore density is accompanied by a lower weight, in particular whenever the pores are unfilled and/or are filled with a lightweight material. The electrical and/or thermal conductivity may also be positively influenced by the pore density.

A lightweight material is in this context in particular a lightweight polymer, such as for example polyesters, polyamides, and/or polyolefins such as polyethylene, polypropylene and/or polybutylene.

According to a further aspect of the invention, the structure may be produced at least in some regions from lead and/or a lead alloy in the region of the pores.

Especially when such a structure is used in a lead storage battery, the corrosion resistance of the structure and the functionality of the lead storage battery increase.

According to a further aspect of the invention, the structure may be formed at least in some regions as a conductor rail, a bridge connector, an electrode grid or a pole and/or terminal lug of an electrode plate of an energy storage system, in particular a storage battery of a vehicle, preferably a starter battery of a vehicle.

This makes it clear that the structure is preferably used as a component on which high currents occur. In spite of the structure being of a solid form, the weight is thereby reduced and the mechanical and/or electrical properties are improved, or at least not impaired.

According to a further aspect of the invention, a system which comprises the following is provided: at least one storage battery, in particular one lead storage battery, at least one electrical collector element, which is electrically connected to at least one pole of the storage battery, and at least one structure described above. The structure here is part of the storage battery and/or of the electrical collector element.

An exemplary embodiment which advantageously describes a system of reduced weight, which moreover has improved electrical properties and/or at least not impaired mechanical properties, is described here.

With respect to the method for producing a current-conducting structure, in particular a current-conducting structure described above, first a polymer structure is provided. Then this polymer structure is introduced into a casting mold and the casting mold is filled with molten metal or a molten metal-like substance. The polymer structure is in this case gasified in such a way that closed pores are formed in the cast structure.

This provides a simple method of production, whereby the production costs can be kept low.

According to a further aspect of the invention, the polymer structure may comprise a multiplicity of particles of electrically conductive material, in particular metal, preferably silver, copper, gold, tungsten and/or aluminum, and/or carbon or a carbon-containing substance, preferably carbon fibers or a carbon-fiber-containing substance. In this case, the polymer structure with the particles is designed so as to form pores in the cast structure that are filled with the electrically conductive material.

This achieves the advantage that the cast structure has a high conductivity, while the simple manner of production is retained. Moreover, the weight can also be reduced, in particular if the conductive particles have a lower relative density than the surrounding molten metal or molten metal-like substance, or the metal or the metal-like substance of the cast structure.

According to a further aspect of the invention, the polymer structure may be formed from a polymer foam.

This advantageously leads to a further reduction in the material costs, since less material is required for the polymer structure.

According to a further aspect of the invention, the method may be a low-pressure full-mold casting process.

This is advantageously a low-cost and precise method.

The invention is described in more detail below, including regarding further features and advantages, using the description of embodiments with reference to the accompanying drawings.

In the figures:

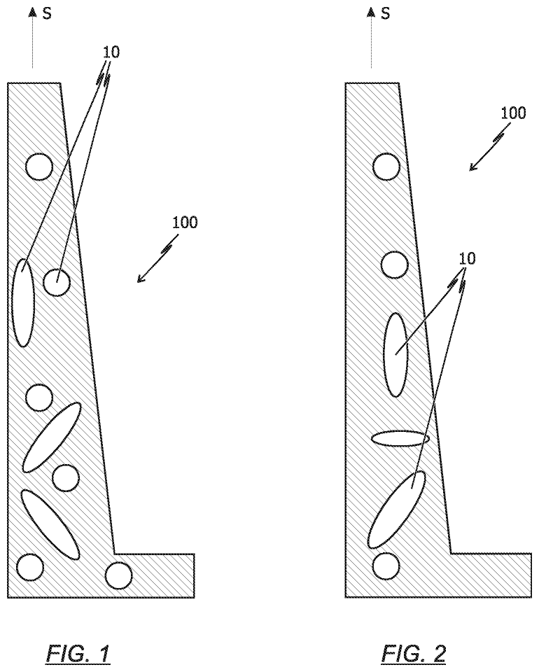

FIG. 1 shows a schematic representation of a current-conducting structure in which the pores are oriented isotropically, or in a homogeneously distributed and isotropic manner;

FIG. 2 shows a schematic representation of a current-conducting structure in which the pores are distributed anisotropically, or inhomogeneously; and

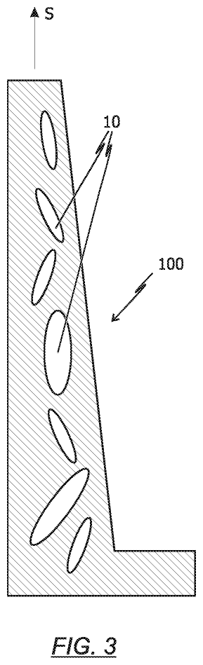

FIG. 3 shows a schematic representation of a current-conducting structure in which the pores are oriented in an inhomogeneously distributed and anisotropic manner.

The current-conducting structure according to the invention and the method for producing such a structure are described below with reference to the representations in FIGS. 1 to 3. Identical or equivalent elements and functions are provided with the same or similar reference signs.

First there follows a more detailed description of general features of a current-conducting structure according to the invention, which can be used on their own or in combination for any current-conducting structure according to the invention; in particular, the following features are not restricted to one embodiment.

With the steadily increasing number of energy consumers, in particular electrical power consumers, supplying a vehicle with energy, in particular with electrical power, is becoming an ever more important concern, not only in vehicles based on the internal combustion engine but also in electric vehicles and in hybrid vehicles. In particular, high currents occur in starter batteries of vehicles.

The vehicle here may be an aircraft or a watercraft, a rail vehicle, an all-terrain vehicle, or preferably a road vehicle, where a road vehicle may mean a passenger car, a truck, a bus, or a motor home.

In addition, a hybrid vehicle may be understood as meaning any vehicle that has both an internal combustion engine and an electric motor as an energy source. Hybrid vehicles can then be divided into micro hybrid, mild hybrid, full hybrid and plug-in hybrid vehicles.

Elements that are designed to pick up, further conduct and/or pass on high currents have at least in some regions a current-conducting structure according to the invention, which has on the one hand good electrical and/or mechanical properties and at the same time as low a weight as possible.

A current-conducting structure according to the invention is formed at least in some regions from a metal or metal-like substance in which a multiplicity of closed pores are formed.

The provision of pores reduces the overall weight of the current-conducting structure, to be precise without impairing the electrical and/or mechanical properties, while in particular the electrical properties, preferably the electrical conductivity, are improved. In addition, the feature that the pores are predominantly closed improves the corrosion resistance of the current-conducting structure, to be precise because the surface area that is exposed to the electrolyte is not increased but remains the same. As a result, the corrosion properties of the current-conducting structure remain unchanged, in particular in comparison with a solidly formed structure of the same outer shape and size.

Therefore, the current-conducting structure according to the invention has a surface of at least substantially unchanged material, in particular when the surface is exposed to a corrosion process.

In a cross section of the current-conducting structure along the current-conducting direction, the pores may have an at least substantially round cross section and/or an at least substantially non-round cross section, in particular an oval cross section.

In this context, a pore with an at least substantially non-round cross section is understood as meaning a pore that has a cross section with a longitudinal axis or preferred axis, on the basis of which the pores can be oriented in one direction, in particular in the current-conducting direction.

The size of pores with an at least substantially non-round cross section is preferably given in this context with reference to the size of the pores along their longitudinal axis or preferred axis.

A pore that is at least substantially round in cross section is preferably accompanied by a spherical pore in the current-conducting structure. In addition, the current-conducting structure may comprise rod-shaped, platelet-shaped, fiber-shaped, ovoid-shaped, and/or ellipsoid-shaped pores.

Spherical pores have the advantage that they do not have to be aligned in advance in the production of the current-conducting structure. Rod-shaped, platelet-shaped, fiber-shaped, ovoid-shaped, and/or ellipsoid-shaped pores are preferably aligned in such a way that their longitudinal axis or preferred axis points at least substantially in the current-conducting direction. As a result, the electrical properties, in particular the electrical conductivity, can be advantageously improved, while at the same time the mechanical properties are at least not impaired.

The pores may be arranged inhomogeneously distributed in the current-conducting structure. An inhomogeneous distribution of the pores means in this context that the pores are unevenly distributed, in particular that the pores are arranged in an inner, centrally located region of the current-conducting structure, preferably along the current-conducting direction.

The pores may also be oriented anisotropically, i.e. aligned in one direction; to be precise, pores that have an at least substantially non-round cross section, and consequently preferably a longitudinal direction or preferred direction, in particular an oval cross section, can be aligned in such a way that their longitudinal axis is oriented at least substantially in the current-conducting direction.

At least some of the closed pores of the current-conducting structure may be filled with the following: a vacuum, a pure gas and/or a lightweight material. This advantageously leads to a weight reduction of the current-conducting structure, to be precise without impairing the electrical and/or mechanical properties.

The lightweight material here may be in particular a lightweight polymer, such as for example polyesters, polyamides, and/or polyolefins. The group of polyolefins include for example polyethylenes, polypropylenes and/or polybutylenes or copolymers thereof.

At least some of the closed pores of the current-conducting structure may be filled with an electrically conducting material, in particular with metal. The pores may preferably be filled with silver, copper, gold, tungsten and/or aluminum. It is also conceivable to use carbon or a carbon-containing substance as the filling material, in particular in the form of carbon fibers or a carbon-fiber-containing substance.

This improves at least the electrical properties, in particular the electrical conductivity, and may additionally reduce the weight of the current-conducting structure if the electrically conducting material is lighter, i.e. has a lower density, than the metal forming the region or the metal-like substance forming the region.

The provision of closed pores leads to a so-called apparent relative density, which—in comparison with a solidly formed structure, i.e. a non-porous structure, of the same outer shape and size—is lower than the relative density of the solidly formed structure. At the same time, the corrosion properties are unchanged, and the electrical and/or mechanical properties are improved, or at least substantially unimpaired.

A current-conducting structure may be an at least substantially solid element, i.e. have a high material density at least in some regions. The current-conducting structure may therefore have at least in the region of the pores a thickness of at least approximately 2 mm, preferably at least approximately 5 mm, particularly preferably at least approximately 10 mm. As a result of the porous form taken by the current-conducting structure, the weight is not excessively great in spite of the solid form. In particular, the size, preferably the thickness, of the current-conducting structure is dictated by the requirement that the mechanical properties, such as for example the bending strength and/or the breaking strength, must be retained even when there are high current flows.

In the case of a lead storage battery, the surfaces exposed to the electrolyte, in particular the region around the pores, may be produced from lead and/or a lead alloy. This increases the functionality and electrical properties of the lead storage battery. The current-conducting structures in the lead storage battery contribute considerably to the overall weight, since lead has on the one hand a high relative density and on the other hand a relatively low specific conductivity. By porously forming the current-conducting structure, the apparent relative density of the porous lead structure is reduced. This produces a current-conducting structure with a lower weight with the same outer shape and unchanged corrosion properties.

In addition, the current-conducting structure may comprise, in particular in the region of the pores, nickel and/or a nickel alloy, silver and/or a silver alloy, lithium and/or a lithium alloy, aluminum and/or an aluminum alloy, copper and/or a copper alloy, or sodium and/or a sodium alloy.

A current-conducting structure may also be formed at least in some regions as a conductor rail, a bridge connector, an electrode grid or a pole and/or terminal lug of an electrode plate of an energy storage system. Furthermore, in the case of a lead storage battery, the current-conducting structure may similarly form at least in some regions the so-called head lead, the head lead being understood as meaning the bridges and connectors of an electrode plate and/or of a battery module.

The current-conducting structure according to the invention can be used or provided anywhere where high currents are transmitted or drawn. In particular, the current-conducting structure may also be used in generator systems and/or in energy storage systems, in particular storage batteries of vehicles, preferably a starter battery of a vehicle.

The current-conducting structure according to the invention may have at least in some regions a pore density of at least 5 pores/cm², preferably at least 10 pores/cm², particularly preferably at least 20 pores/cm².

It is equally quite conceivable here to give the pore density in a volumetric unit. In this case, the current-conducting structure according to the invention may have at least in some regions a pore density of at least 5 pores/cm³, preferably at least 10 pores/cm³, particularly preferably at least 20 pores/cm³.

A current-conducting structure according to the invention may comprise a first group of pores with a size of approximately 10 μm to approximately 500 μm, preferably with a size of approximately 50 μm to approximately 300 μm, particularly preferably a size of approximately 100 μm to approximately 200 μm.

Furthermore, a structure according to the invention may comprise in addition to the first group of pores or instead of the first group of pores a further group of pores with a size of at least 1 mm.

The first group of pores can increase the mechanical stability, or at least not impair it, and is a compromise between good electrical properties, in particular electrical conductivity, and the mechanical properties.

The further group of pores can advantageously be produced more easily; it can also be arranged and oriented more easily and better.

There follows a description of three embodiments, which are given by way of example and schematically represented in the drawings and in which the different distributions and orientations of the pores are better illustrated.

In FIG. 1, an exemplary embodiment of a current-conducting structure 100 is represented, with a multiplicity of closed pores 10, which are located in a region of the current-conducting structure 100 that is formed from a metal or a metal-like substance. Furthermore, in FIG. 1, an exemplary current-conducting direction S is indicated. It is evident that the closed pores 10 are distributed homogeneously in the region of the current-conducting structure 100, and that the pores 10 are also oriented isotropically. That is to say that the pores 10 are arranged evenly distributed in the current-conducting structure 100 and are not aligned substantially in one direction, in particular not in the current-conducting direction S.

This leads to a weight reduction of the current-conducting structure 100. However, the electrical properties, in particular the electrical conductivity, may be impaired thereby. Among the causes of this may be that at least some of the pores 10—to be more precise at least some of the substantially non-round pores 10, i.e. the pores 10 that have a longitudinal direction or preferred direction—are arranged such that their preferred direction runs transversely in relation to the current-conducting direction S.

FIG. 2 shows an embodiment that is given by way of example, in which the multiplicity of pores 10 are arranged inhomogeneously in the region of the current-conducting structure 100 that is formed from metal or a metal-like substance. That is to say that the pores 10 are arranged unevenly distributed in the current-conducting structure 100; in particular, the pores 10 are arranged—preferably along a current-conducting direction S—in an inner, centrally located region of the current-conducting structure 100. Such a current-conducting direction S is indicated in FIG. 2 by way of example with the aid of an arrow.

The pores 10 are preferably not arranged in the proximity of the surfaces of the current-conducting structure 100, particularly preferably likewise no pores 10 are arranged in angular regions and/or in regions in which a welded connection is provided. The orientation of the pores 10 in this embodiment is substantially isotropic, i.e. no alignment of the pores 10 in one direction, in particular in the current-conducting direction S, is provided.

Such a distribution of the pores 10 leads to an improvement in the electrical and/or mechanical properties, in particular the electrical conductivity, and to a weight reduction of the current-conducting structure 100.

FIG. 3 shows an exemplary embodiment in which the pores 10 are arranged inhomogeneously in the current-conducting structure 100, i.e. are arranged unevenly in the current-conducting structure 100, and at the same time have an anisotropic orientation, in particular in the current-conducting direction S, which is indicated by way of example by an arrow, to be precise in such a way that at least some of the pores 10, preferably all of the pores 10, have a substantially non-round cross section—i.e. pores 10 with a longitudinal direction or preferred direction—in particular with an oval cross section. The longitudinal axis or preferred axis of the cross-sectionally substantially non-round pores 10 is in this case oriented in the current-conducting direction S. Such an orientation of the pores 10 especially improves the electrical properties of the current-conducting structure 100, in particular the electrical conductivity of the structure 100.

Even if it is not shown explicitly in the drawings, it is also conceivable that the pores 10 are arranged distributed homogeneously in the current-conducting structure 100, i.e. evenly distributed, and at least some of the pores 10, preferably all of the pores 10, have an anisotropic orientation, in particular in the current-conducting direction S, to be precise in such a way that at least some of the pores 10, preferably all of the pores 10, have a substantially non-round cross section, i.e. pores 10 with a longitudinal direction or preferred direction, in particular with an oval cross section, the longitudinal axis or preferred axis of which is preferably oriented in the current-conducting direction S. As a result, the electrical properties, in particular the electrical conductivity, and/or the mechanical properties are likewise improved.

In a further embodiment of the invention, which is not depicted in the drawings, a system which respectively comprises at least one of the following elements is provided: a storage battery, in particular a lead storage battery, an electrical collector element, which is electrically connected to at least one pole of the storage battery, and a structure 100 described above. The structure 100 here is part of the storage battery and/or of the electrical collector element.

The use of a current-conducting structure 100 described above as part of a storage battery and/or of an electrical collector element leads to a weight reduction of the system and at the same time to the improvement of the electrical and/or mechanical properties of the system, in particular the electrical conductivity.

The system may alternatively also relate to a generator system in which at least one electrical feed element is formed instead of the electrical collector elements, and the system additionally has an electrical generator. The current-conducting structure 100 may in this case be part of the storage battery and/or of the electrical feed element and/or of the generator.

A current-conducting structure 100, in particular one of the current-conducting structures 100 described above, may be produced as follows.

First a polymer structure is provided and is introduced into a casting mold. Then the casting mold is filled with a molten metal or a molten metal-like substance. The polymer structure is in this case gasified in such a way that closed pores 10 are formed in the cast structure 100. A simple and efficient method for producing a current-conducting structure 100 is described here. Moreover, it can be performed at low cost and leads to a current-conducting structure 100 of reduced weight.

The polymer structure may also be formed from a polymer foam, which has the effect that less material is required for the polymer structure. This also leads to a cost reduction. Preferably, empty pores 10, i.e. pores 10 filled with a vacuum, and/or pores 10 filled with a pure gas may be produced with a polymer structure of polymer foam.

In order to form pores 10 filled with electrically conductive material, the polymer structure may comprise a multiplicity of particles of the electrically conductive material, in particular metal. The metal is preferably silver, copper, gold, tungsten and/or aluminum. It is also conceivable to use carbon or a carbon-containing substance as the filling material. For this purpose, the polymer structure may comprise a multiplicity of carbon particles or of particles of the carbon-containing substance, in particular in the form of carbon fibers or parts thereof.

As a result, the pores 10 may advantageously be already filled with electrically conductive material when they are created. As a result, the electrical conductivity of the current-conducting structure 100 is increased, while the simple sequence of the method is retained.

The method may preferably be a low-pressure full-mold casting process. This allows the current-conducting structure 100 to be produced at low cost and easily, but precisely.

The polymer structure in this case predetermines the position and orientation of the later pores 10 from the outset.

The pores 10 that are filled with electrically conductive material, which preferably have a substantially non-round cross section, can as a result already be brought into position and aligned in the direction of the current-conducting direction S. The finished casting can therefore contain the inclusions with good conducting properties, i.e. the pores 10 filled with conductive material, and possibly just a few empty pores 10.

At this point it should be noted that all the parts described above, viewed on their own and in any combination, in particular the details shown in the drawings, are claimed as essential to the invention. Amendments thereof are familiar to the person skilled in the art.

1. A current-conducting structure (100), in particular for use in an energy storage system of a vehicle, wherein the current-conducting structure (100) is formed at least in some regions from a metal or metal-like substance in which a multiplicity of closed pores (10) are formed.

2. The structure (100) of claim 1, wherein the pores (10) have at least partially a substantially round cross section.

3. The structure (100) of claim 1, wherein the pores (10) have at least partially a substantially non-round cross section, in particular a substantially oval cross section.

4. The structure (100) of claim 1, wherein the structure (100) has at least in the region of the pores a thickness of at least approximately 2 mm.

5. The structure (100) of claim 1, wherein the pores (10) are distributed inhomogeneously in the structure (100), in particular in the current-conducting direction (S).

6. The structure (100) of claim 1, wherein the pores (10) have at least partially an anisotropic orientation, wherein at least some of the pores (10) have a substantially non-round cross section, the longitudinal axis of which is substantially oriented in the current-conducting direction (S).

7. The structure (100) of claim 1, wherein at least some of the pores (10) are filled with a vacuum, a gas and/or a polymer.

8. The structure (100) of claim 1, wherein at least some of the pores (10) are filled with an electrically conducting material.

9. The structure (100) of claim 8, wherein the electrically conducting material comprises metal, and/or carbon or a carbon-containing substance.

10. The structure (100) of claim 1, wherein the structure (100) comprises a first group of pores with a size of approximately 10 μm to approximately 500 μm.

11. The structure (100) of claim 1, wherein the structure (100) comprises a further group of pores with a size of at least 1 mm.

12. The structure (100) of claim 1, wherein the structure (100) has at least in some regions a pore density of at least approximately 5 pores/cm².

13. The structure (100) of claim 1, wherein the structure (100) is produced at least in some regions from lead and/or a lead alloy in the region of the pores (10).

14. The structure (100) of claim 1, wherein the structure (100) is formed at least in some regions as a conductor rail, a bridge connector, an electrode grid or a pole and/or terminal lug of an electrode plate of an energy storage system.

15. A system which comprises the following:
at least one storage battery, in particular a lead storage battery;
at least one electrical collector element, which is electrically connected to at least one pole of the storage battery; and
at least one structure (100) as claimed in claim 1,
wherein the structure (100) is part of the storage battery and/or of the electrical collector element.

16. A method for producing a current-conducting structure, in particular a structure (100) as claimed in claim 1, wherein the method comprises the following steps:
providing a polymer structure;
introducing the polymer structure into a casting mold; and
filling the casting mold with a molten metal or a molten metal-like substance,
wherein the polymer structure is gasified in such a way that closed pores (10) are foamed in the cast structure (100).

17. The method of claim 16, wherein the polymer structure comprises a multiplicity of particles of electrically conductive material, in particular metal and/or carbon or a carbon-containing substance, and wherein the polymer structure with the particles is designed so as to form pores (10) in the cast structure (100) that are filled with the electrically conductive material.

18. The method of claim 16, wherein the polymer structure is formed from a polymer foam.

19. The method of claim 16, wherein the method is a low-pressure full-mold casting process.

20. The structure (100) of claim 1, wherein the structure (100) has at least in the region of the pores a thickness of at least approximately 5 mm.

21. The structure (100) of claim 1, wherein the structure (100) has at least in the region of the pores a thickness of at least approximately 10 mm.

22. The structure (100) of claim 1, wherein the pores (10) have at least partially an anisotropic orientation, wherein at least some of the pores (10) have an oval cross section, the longitudinal axis of which is substantially oriented in the current-conducting direction (S).

23. The structure (100) of claim 9, wherein the electrically conducting material comprises silver, copper, gold, tungsten and/or aluminum, and/or carbon or a carbon-containing substance.

24. The structure (100) of claim 9, wherein the carbon or a carbon-containing substance comprises carbon fibers or a carbon-fiber-containing substance.

25. The structure (100) of claim 1, wherein the structure (100) comprises a first group of pores with a size of approximately 50 μm to approximately 300 μm.

26. The structure (100) of claim 1, wherein the structure (100) comprises a first group of pores with a size of approximately 100 μm to approximately 200 μm.

27. The structure (100) of claim 1, wherein the structure (100) has at least in some regions a pore density of at least approximately 10 pores/cm².

28. The structure (100) of claim 1, wherein the structure (100) has at least in some regions a pore density of at least approximately 20 pores/cm².

29. The structure (100) of claim 1, wherein the structure (100) is formed at least in some regions as a conductor rail, a bridge connector, an electrode grid or a pole and/or terminal lug of an electrode plate of a storage battery of a vehicle.

30. The structure (100) of claim 1, wherein the structure (100) is formed at least in some regions as a conductor rail, a bridge connector, an electrode grid or a pole and/or terminal lug of an electrode plate of a starter battery of a vehicle.

31. The method of claim 17, wherein the polymer structure comprises a multiplicity of particles of electrically conductive material, in particular silver, copper, gold, tungsten and/or aluminum, and/or carbon or a carbon-containing substance, and wherein the polymer structure with the particles is designed so as to form pores (10) in the cast structure (100) that are filled with the electrically conductive material.

32. The method of claim 17, wherein the carbon or carbon-containing substance comprises carbon fibers or a carbon-fiber-containing substance.
